(19) United States
(12) Patent Application Publication
(10) Pub. No.: US 2009/0011793 A1
(43) Pub. Date: Jan. 8, 2009

(54) Flash Memory Cell Phone With Integrated Male And Female Connectors

(76) Inventor: Alan L. Pocrass, Simi Valley, CA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/813,641

(22) PCT Filed: Jan. 13, 2006
(86) PCT No.: PCT/US2006/001375

§ 371 Date: May 21, 2008

Related U.S. Application Data
(60) Provisional application No. 60/644,148, filed on Jan. 13, 2005.

(51) Int. Cl. H04M 1/02; H04B 1/38

(52) U.S. Cl. 455/556.1; 455/557

(57) ABSTRACT

The invention is a cell phone (1) having a housing (3) operatively enclosing a keyboard K, a display D and cell phone circuitry C. A male USB connector (9) is at least partially enclosed by the housing (3) and a female USB connector (11) is at least partially enclosed by the housing (3). The cell phone circuitry C includes flash memory (13) and circuitry (15, 17) for enabling data to be transferred to or from the flash memory (13) via the male and female USB connectors (9 and 11).

### CROSS REFERENCE TO RELATED APPLICATIONS

This application claims priority from U.S. Provisional Patent Application No. 60/644,148, filed Jan. 13, 2005, which is incorporated herein by reference.

### BACKGROUND OF THE INVENTION

1. Field of the Invention

The present invention relates to cell phones, and, more particularly, to a cell phone with integrated male and female connectors for transferring data to/from the cell phone.

2. Description of Related Art

Prior art cell phones do not include any means, other than wireless communication, for transferring data to/from the cell phone and another device, e.g., without limitation, another cell phone, without the use of a computer, a palm device or other like intelligent device. While the transfer of data utilizing wireless communication is possible with a number of different methods, such as Bluetooth, WiFi or cellular telephone technology, these methods limit the file sharing capabilities of the cell phone. Furthermore, these methods do not provide a fast means to transfer or copy data from one cell phone to another at high speeds.

Accordingly, a need exists for a cell phone that can transmit data stored therein or receive data for storage therein from another device, including another cell phone, via one or more connectors without the use of wireless communication or without the use of an intelligent device, like a computer, a palm device, etc. Still other needs that the present invention fulfills will become apparent to those of ordinary skill in the art upon reading and understanding the following Detailed Description.

### SUMMARY OF THE INVENTION

The invention is a cell phone comprising at least one housing operatively enclosing a keyboard, a display and cell phone circuitry. A male connector is at least partially enclosed by the housing and a female connector, configured to mate with the male connector, is at least partially enclosed by the housing. The cell phone circuitry includes a flash memory and means for enabling data to be transferred to or from the flash memory via the male and female connectors. At least one of said connectors is configured to mate with a mating connector of another device for transferring data to or from the flash memory.

The cell phone can include a battery coupled to provide power to the cell phone circuitry and/or a means for facilitating electrical connection of at least one of said connectors with the mating connector of the other device.

The device can be one of: another, like cell phone; a flash memory drive; a desktop or laptop computer; a palm device; a printer; a digital camera; and a scanner.

The cell phone can further include means for causing the transfer of data to or from the flash memory of the cell phone and/or means for setting the cell phone to transfer data to or from its flash memory.

A means for indicating that the transfer of data is in progress can also or alternatively be provided.

The cell phone can further include means for retrieving digital audio data from the flash memory; means for decoding the retrieved digital audio data; means for converting the decoded digital audio data into an analog signal; and an output connector for outputting the analog signal.

At least one of the male connector and the female connector can be a USB connector.

The invention is also a method of transferring data to/from a cell phone having integral male and female connectors from/to a device having a connector configured to mate with one of the connectors of the cell phone. The method includes mating one of the connectors of the cell phone with the mating connector of the device; and causing data to transfer from the cell phone to the device, or vice versa, via the mated connectors.

The method can further include setting the cell phone to be a master or a slave, wherein the data transfer occurs as a function of the setting of the cell phone as the master or the slave.

The male and female connectors of the cell phone can be USB connectors.

Lastly, the invention is a cell phone that comprises an enclosure; a male USB connector at least partially received within the enclosure; a female USB connector at least partially received within the enclosure; a flash memory disposed in the enclosure; and means disposed in the enclosure for transferring data to or from the flash memory via at least one of the male USB connector and the female USB connector when said connector is mated with a female USB connector or a male USB connector, respectively, of another device.

A battery can be coupled to provide power to the flash memory and the means for transferring.

The cell phone can further include means for causing the means for transferring to initiate the transfer of data to or from the flash memory; means for setting said cell phone as a master or a slave and for transferring data to or from the flash memory as a function of said setting; and/or means for facilitating electrical connection of at least one of the female USB connector and the male USB connector of the cell phone to the mating connector of the other device.

### BRIEF DESCRIPTION OF THE DRAWINGS

FIG. 1 is a perspective view of an exemplary cell phone 1 in accordance with the present invention including a male USB connector and a female USB connector;

FIG. 2 is a schematic of various components, electrical and mechanical, comprising the cell phone shown in FIG. 1;

FIG. 3 is a perspective view showing the mating of the male connector of one cell phone in accordance the present invention with the mating female connector of another cell phone in accordance with the present invention;

FIG. 4 is a perspective view of a cable having a male connector mating with the female connector of the cell phone in FIG. 1; and

FIG. 5 is a schematic of the circuits comprising the digital audio circuit shown in FIG. 2.

### DETAILED DESCRIPTION OF THE INVENTION

The present invention will be described with reference to the accompanying figures where like reference numbers correspond to like elements.

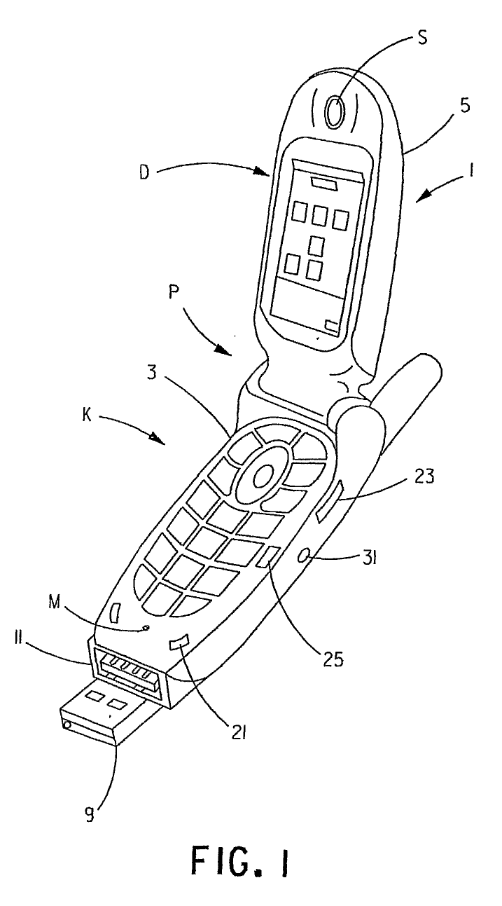

With reference to FIG. 1, a cell phone 1 in accordance with the present invention includes a keyboard housing 3 configured to house a keyboard K having one or more buttons, a microphone M and related components and hardware required to electrically and physically support the operation of keyboard K, microphone M and the wireless transmitting and receiving functions of cell phone 1 in a manner known in the art. The illustrated embodiment of cell phone 1 further includes a display housing 5 configured to house a display D, a speaker S and related components and hardware required to electrically and physically support the operation of display D and speaker S in a manner known in the art.

The embodiment of cell phone 1 shown in FIG. 1 is a so-called flip-type phone wherein keyboard housing 3 and display housing 5 are pivotally joined together by a pivot joint P formed by the configuration and cooperation of keyboard housing 3 and display housing 5 in a manner known in the art. However, this is not to be construed as limiting the invention since it is envisioned that another embodiment of cell phone 1 in accordance with the present invention can comprise a single housing (not shown) for housing the components and hardware described generally above in connection with the embodiment of cell phone 1 shown in FIG. 1. For purpose of describing the present invention, reference hereinafter will be made to the embodiment of cell phone 1 shown in FIG. 1. However, this is not to be construed as limiting the invention since the use of any configuration of a cell phone is envisioned.

In accordance with the present invention, cell phone 1 includes a male USB connector 9 and a female USB connector 11. Desirably connectors 9 and 11 are mini or mini-B type USB connectors. However, this is not to be construed as limiting the invention since it is envisioned that one or both of connectors 9 and 11 can be a USB-A type connector. Male USB connector 9 and female USB connector 11 are supported at least partially within keyboard housing K in any suitable manner known in the art, e.g., without limitation, via a printed circuit board.

Male USB connector 9 is configured to mate with a corresponding female USB connector of another device, such as, without limitation, another cell phone 1 in accordance with the present invention, a desktop or laptop computer, a palm device, an interface cable, etc. Female USB connector 11 is also configured to mate with a corresponding male USB connector of another device, such as, without limitation, another cell phone 1 in accordance with the present invention, an interface cable or a flash memory drive. The latter flash memory drive can either be a prior art flash memory drive, like the Lexar 256 MB USB 2.0 Jumpdrive, commercially available in the U.S. from the TigerDirect.com website, or a flash memory drive of the type disclosed in co-pending U.S. patent application Ser. No. 11/028,382, filed Jan. 3, 2005, having an integrated male USB connector and a female USB connector, which is incorporated herein by reference, and which is commercially available in the U.S. under the trademark “Flashpoint Sharedrive” from the XMultiple.com website.

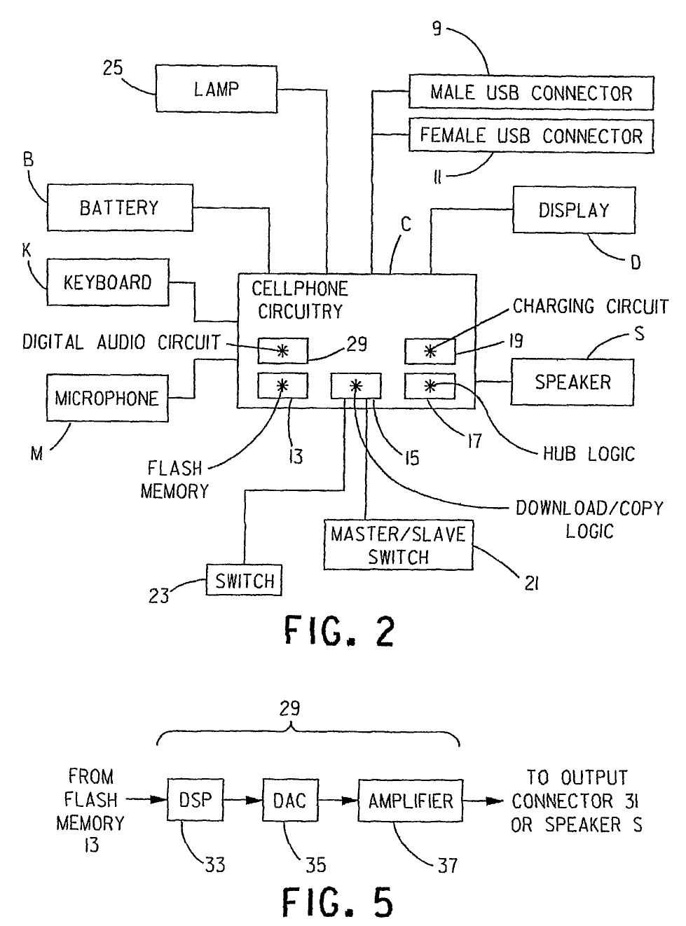

With reference to FIG. 2 and with continuing reference to FIG. 1, internal to keyboard housing 3 and/or display housing 5, cell phone 1 includes cell phone circuitry C, a battery B, a keyboard K, a microphone M, a display D and a speaker S. Cell phone circuitry C includes all of the necessary circuitry for supporting the software and hardware functions of cell phone 1 found in prior art cell phones, such as, without limitation, one or more flash memories, either integral on a chip with other circuits of cell phone circuitry C or as one or more standalone flash memories 13. For the purpose of describing the present invention, it will be assumed hereinafter that cell phone circuitry C includes one or more standalone flash memory chips 13. However, this is not to be construed as limiting the invention since it is envisioned that the storage function performed by each standalone flash memory chip 13 can be incorporated into another chip of cell phone circuitry C.

In addition to including one or more flash memories 13, cell phone circuitry C of cell phone 1 includes a download/copy logic circuit 15 and a hub logic circuit 17, both of which support the transfer of data to or from flash memory chip 13 via male USB connector 9 and/or female USB connector 11 in a manner to be described hereinafter. Each of download/copy logic circuit 15 and hub logic circuit 17 can either be integral on a chip with other circuits of cell phone circuitry C or can be realized as standalone chips. For purpose of describing the present invention, it will be assumed hereinafter that cell phone circuitry C includes a standalone download/copy logic chip 15 and a standalone hub logic chip 17. However, this is not to be construed as limiting the invention since the function performed by one or both of chips 15 and 17 can be incorporated into another chip of cell phone circuitry C.

It is to be appreciated that battery B, cell phone circuitry C, including flash memory chip 13, download/copy logic chip 15 and hub logic chip 17, keyboard K, microphone M, display D and speaker S can be housed in keyboard housing 3 and/or display housing 5 of cell phone 1 in any manner deemed necessary and/or desirable by one skilled in the art. Moreover, the stacked arrangement of male and female USB connectors 9 and 11, respectively, extending from the microphone end of keyboard housing 3 in FIG. 1 is not to be construed as limiting the invention since it is envisioned that each said connector can be mounted anywhere in keyboard housing 3 or display housing 5 as deemed necessary and/or desirable by one skilled in the art. Accordingly, the stacked arrangement of connectors 9 and 11 at the microphone M end of keyboard housing 3 is not to be construed as limiting the invention.

Download/copy logic chip 15 is electrically connected to flash memory chip 13 for facilitating the transfer of data stored in flash memory chip 13 to and/or from another device such as, without limitation, the flash memory of another, like cell phone 1, a flash memory drive, a desktop or laptop computer, a palm device, a printer, a digital camera, a gaming device, a scanner, and the like. Hub logic chip 17 is connected and operative for facilitating connection of one or both of male USB connector 9 and female USB connector 11 to a universal serial bus having connected thereto said other device. Battery B provides electrical power to cell phone circuitry C, including flash memory chip 13, download/copy logic chip 15 and hub logic chip 17, to support the electrical operation thereof when cell phone 1 is not attached to an external power source or the USB port of an externally powered device, such as a computer, a palm device, etc. Battery B providing electrical power to the combination of flash memory chip 13, download/copy logic chip 15 and hub logic chip 17 thereby enables data to be transferred to/from flash memory chip 13 from/to another device attached to male USB connector 9 or female USB connector 11 without the use of externally provided power. Cell phone circuitry C can include a charging circuit 19 that facilitates the charging of battery B when male USB connector 9 or female USB connector 11 is connected to an externally powered device.

The disclosure herein of cell phone 1 including battery B is not to be construed as limiting the invention since it is envisioned that cell phone 1 may also or alternatively include other power supplies, such as one or more solar cells, that can be utilized to power cell phone circuitry C. The circuits of cell phone circuitry C normally associated with the functions of a prior art cell phone as well as flash memory chip 2, download/copy logic chip 15, hub logic chip 17 and charging circuit 19 can be implemented on one or more integrated circuit chips in any suitable and/or desirable manner deemed necessary and/or desirable by one of ordinary skill in the art.

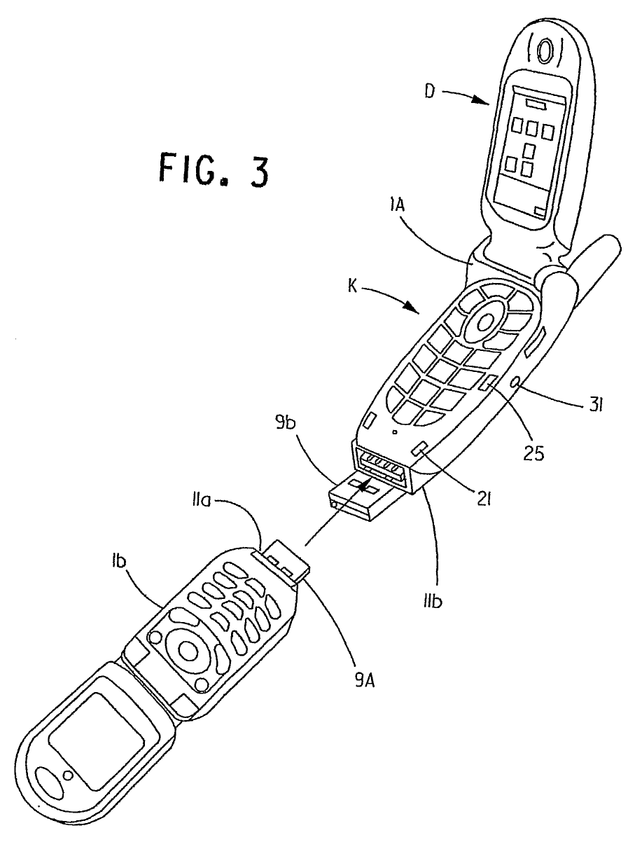

With reference to FIG. 3 and with continuing reference to FIGS. 1 and 2, a first cell phone 1a and a second cell phone 1b, both in accordance with the present invention, can be communicatively joined together by mating the male USB connector 9a of first cell phone 1a with the female USB connector 11b of second cell phone 1b, or by mating the male USB connector 11a of second cell phone 1b with the female USB connector 9b of first cell phone 1a for the purpose of transferring or copying data from the flash memory chip 13 of first cell phone 1a to the flash memory chip 13 of second cell phone 1b, or vice versa.

Each cell phone 1 in accordance with the present invention can include a master/slave switch 21 coupled to download/copy logic chip 15 for setting cell phone 1 as either a master or a slave. In operation, when first cell phone 1a and second cell phone 1b are communicatively joined together, the cell phone 1 set to be the master (transmitting unit) by its master/slave switch transfers data from its flash memory chip 13 to the flash memory chip 13 of the cell phone 1 set to be the slave (receiving unit) by its master/slave switch under the control of download/copy logic chip 15 of the cell phone 1 set as the master. For example, first cell phone flash memory drive 1a can be set as the master and second cell phone 1b can be set as the slave using their respective master/slave switches 21. Hence, when first cell phone 1a (set as the master) and second cell phone 1b (set as the slave) are communicatively joined together, data is transferred from the flash memory chip 13 of first cell phone 1a to the flash memory chip 13 of second cell phone 1b under the control of the download/copy chip 15 of cell phone 1a.

Desirably, download/copy logic chip 15 of each cell phone 1 set as a master controls the transfer of data from its flash memory chip 13 to another device connected to cell phone 1 by its male or female USB connector 9 or 11. Alternatively, when each cell phone 1 is set as a slave, download/copy logic chip 15 initially assumes a passive role in the download of data into its flash memory chip 13 when cell phone 1 is connected via its male or female USB connector 9 or 11 to another device. However, if the device connected to cell phone 1 is a passive device, such as a prior art flash memory drive, download/copy logic chip 15 can be configured to assume control of the download of data into the flash memory chip 13 of its cell phone 1 even when said cell phone 1 is set as a slave.

Also or alternatively, the function of switch 21 to set cell phone 1 as a master or a slave can be accomplished programmatically via cell phone circuitry C, keyboard K and display D of cell phone 1 whereupon switch 21 may be omitted. To this end, keyboard K, display D and cell phone circuitry C can be configured to enable a user of cell phone 1 to program cell phone 1 as a master or slave as desired.

Cell phone 1 in accordance with the present invention can also be utilized with flash memory drives such as prior art flash memory drives or flash memory drives of the type disclosed in co-pending U.S. patent application Ser. No. 11/028,382, filed Jan. 3, 2005, having integrated male and female USB connectors which are commercially available in the U.S. under the trademark “Flashpoint Sharedrive” from the XMultiple.com website. To this end, when a cell phone 1 in accordance with the present invention is utilized with a flash memory drive having a USB connector thereof coupled with a mating USB connector of cell phone 1, cell phone 1 can be set as the master for transferring data from its flash memory chip 13 to the flash memory chip of the flash memory drive. Alternatively, cell phone 1 can be set as the slave for transferring data into its flash memory chip 13 from the flash memory chip of the flash memory drive. Desirably, when cell phone 1 is connected to a prior art flash memory drive that does not include an intelligent controller, download/copy logic chip 15 controls the transfer data into the flash memory chip 13 of its cell phone 1 when said cell phone 1 is set as a slave.

Cell phone circuitry C can be configured to enable a user of cell phone 1 to programmatically select via keyboard K and display D which data or data file to transfer to/from its flash memory chip 13 from/to a device communicatively joined to cell phone 1 via its male or female USB connector 9 or 11.

When male USB connector 9 of a cell phone 1 in accordance with the present invention is mated with a female USB connector of another intelligent device, such as a computer, a palm device, and the like, the transfer of data to the flash memory chip 13 of cell phone 1 can be controlled via the device in a manner known in the art. Desirably, it is only when cell phone 1 is set as the master that download/copy logic chip 15 is operative for controlling the transfer of data from its flash memory chip 13. In contrast, when cell phone 1 is set as a slave, data can be transferred into its flash memory chip 13 under the control of another device, such as another cell phone 1 in accordance with the present invention, a computer, a palm device, etc., having the necessary intelligent controller for controlling such data transfer.

Each cell phone 1 can include a push button switch 23 accessible via keyboard housing 3 and coupled to download/copy logic circuit 15 which allows for manual activation of the transfer of data into or out of flash memory chip 13 of cell phone 1. For example, in response to activation of push button switch 23 of cell phone 1a set as a master, download/copy logic circuit 15 of first cell phone 1a transfers data from its flash memory chip 13 to another device communicatively joined thereto.

Also or alternatively, the function of push button switch 23 can be implemented programmatically via cell phone circuitry C, keyboard K and display D of cell phone 1 whereupon push button switch 23 may be omitted.

Each cell phone 1 can also include an optional lamp 25 that is illuminated and visible when data is being transferred to or from the flash memory chip 13 of cell phone 1. Lamp 25 may be selected from any light emitting device suitable for such an application, such as, without limitation, a light emitting diode (LED).

Also or alternatively, the notice provided by lamp 25 can be implemented by display D which can be operative under the control of cell phone circuitry C for displaying a suitable indication when data is being transferred to or from its flash memory chip 13, whereupon lamp 25 may be omitted. If desired, display D can display a first indication when data is being transmitted from cell phone 1 and can display a second indication when data is being received by cell phone 1.

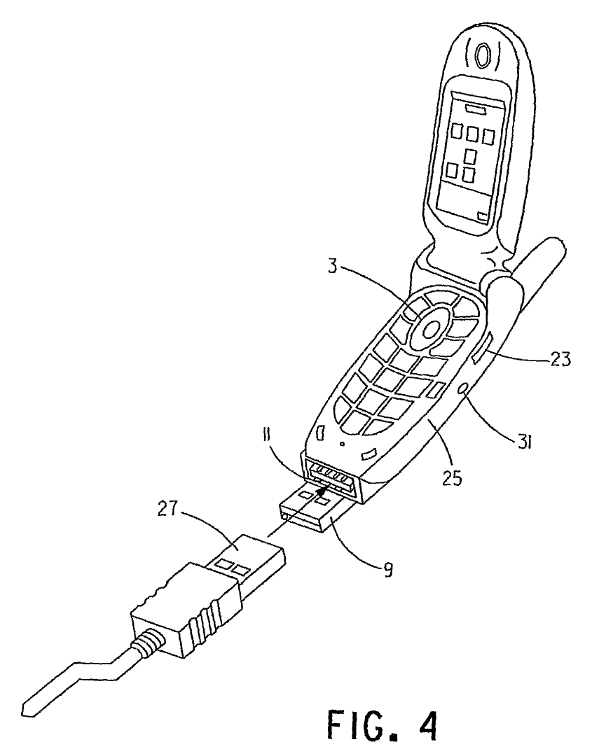

With reference to FIG. 4 and with continuing reference to FIGS. 1 and 2, cell phone 1 may also be used to maximize the available USB ports on a computer, a palm device, etc. Specifically, male USB connector 9 of cell phone 1 may be inserted into a female USB port of a computer (not shown). Thereafter, female USB connector 11 of cell phone 1 can accept a male USB connector 27 of a USB cable. This enables peripheral devices, such as, without limitation, cameras, printers, scanners, flash memory drives, other cell phones in accordance with the present invention, and the like, to utilize the same USB port on the computer as cell phone 1.

With reference back to FIG. 2, if desired, cell phone 1 in accordance with the present invention can include a digital audio circuit 29, integral with another circuit of cell phone circuitry C or as a standalone chip, and an output connector 31, such as a headphone jack. Digital audio circuit 29 includes a digital signal processor (DSP), an amplifier 37 and a digital-to-analog converter (DAC) 35. DSP 33 can retrieve digital audio data from flash memory chip 13 and can decode said digital audio data utilizing a decompression algorithm, such as a MP3 or WMA decompression algorithm, that undoes the compression of the digital audio data stored in a corresponding format on flash memory chip 13. Then, DAC 35 converts the decompressed audio data back into analog audio data. Finally, amplifier 37 boosts the strength of the signal and sends it to output connector 31 or to speaker S. Keyboard K can include one or more buttons for controlling digital audio circuit 29. These buttons can perform such functions as increasing/decreasing volume, playing the digital audio data, stopping, pausing, skipping, rewinding, and the like.

Cell phone 1 of the present invention can be configured such that display D can display a visual indication of the title of the digital audio data, the time remaining in a song and/or other such digital audio data and other useful and desirable information. Display D can be a liquid crystal display (LCD), a plasma screen, and the like.

The present invention is also a method for transferring data to or from the flash memory chip 13 of cell phone 1 in accordance with the present invention. In the method, one of the connectors of cell phone in accordance with the present invention is mated with a mating connector of another device, such as, without limitation, another cell phone 1 in accordance with the present invention, a flash memory drive, a computer, a palm device, and the like. Thereafter, data is transferred into or out of cell phone according to the setting of the cell phone as a master or slave, wherein, when the cell phone is set as a master, data is transferred from the cell phone via the one of the connectors and, when the cell phone is set as a slave, data is transferred into the cell phone via the one of the connectors. The transfer of data into or out of the cell phone can be caused by the user activating one or more switches or buttons of the cell phone. The preceding method is illustrative of the transfer of data into or out of cell phones in accordance with the present invention and is not to be construed as limiting the invention.

While the present invention was described with reference to preferred embodiments of the cell phone with integrated male and female connectors, those skilled in the art may make modifications and alterations to the present invention without departing from the scope and spirit of the invention. Accordingly, the above detailed description is intended to be illustrative rather than restrictive. The invention is defined by the appended claims, and all changes to the invention that fall within the meaning and range of equivalency of the claims are to be embraced by their scope.

The invention claimed is:

1. A cell phone comprising:
at least one housing operatively enclosing a keyboard, a display and cell phone circuitry;
a male connector at least partially enclosed by the housing; and
a female connector at least partially enclosed by the housing and configured to mate with the male connector, wherein:
the cell phone circuitry includes a flash memory and means for enabling data to be transferred to or from the flash memory via the male and female connectors; and
at said one of said connectors is configured to mate with a mating connector of another device for transferring data to or from the flash memory.

2. The cell phone of claim 1, further comprising a battery coupled to provide power to the cell phone circuitry.

3. The cell phone of claim 1, further comprising means for facilitating electrical connection of at least one of said connectors with the mating connector of the other device.

4. The cell phone of claim 1, wherein the other device is one of:
another, like cell phone;
a flash memory drive;
a desktop or laptop computer;
a palm device;
a printer;
a digital camera; and
a scanner.

5. The cell phone of claim 1, further comprising means for causing the transfer of data to or from the flash memory of the cell phone.

6. The cell phone of claim 1, further comprising means for setting the cell phone to transfer data to or from its flash memory.

7. The cell phone of claim 1, further comprising means for indicating that the transfer of data is in progress.

8. The cell phone of claim 1, further comprising:
means for retrieving digital audio data from the flash memory;
means for decoding the retrieved digital audio data;
means for converting the decoded digital audio data to an analog signal; and
an output connector for outputting the analog signal.

9. The cell phone of claim 1, wherein at least one of the male connector and the female connector is a USB connector.

10. A method of transferring data to/from a cell phone having integral male and female connectors from/to a device having a connector configured to mate with one of the connectors of the cell phone, the method comprising:
mating one of the connectors of the cell phone with the mating connector of the device; and
causing data to transfer from the cell phone to the device, or vice versa, via the mated connectors.

11. The method of claim 10, further comprising:
setting the cell phone to be a master or a slave, wherein the data transfer occurs as a function of the setting of the cell phone as the master or the slave.

12. The method of claim 10, wherein, the male and female connectors of the cell phone are USB connectors.

13. The method of claim 10, wherein the device is one of:
another, like cell phone;
a flash memory drive;
a desktop or laptop computer;
a pahn device;
a printer;
a digital camera; and
a scanner.

14. A cell phone comprising:
an enclosure;
a male USB connector at least partially received within the enclosure;
a female USB connector at least partially received within the enclosure;
a flash memory disposed in the enclosure; and
means disposed in the enclosure for transferring data to or from the flash memory via at least one of the male USB connector and the female USB connector when said connector is mated with a female USB connector or a male USB connector, respectively, of another device.

15. The cell phone of claim 14, further comprising a battery coupled to provide power to the flash memory and the means for transferring.

16. The cell phone of claim 14, further comprising means for causing the means for transferring to initiate the transfer of data to or from the flash memory.

17. The cell phone of claim 14, further comprising means for setting said cell phone as a master or a slave and for transferring data to or from the flash memory as a function of said setting.

18. The cell phone of claim 14, further comprising means for facilitating electrical connection of at least one of the female USB connector and the male USB of the cell phone to the mating connector of the other device.
